(19) United States
(12) Patent Application Publication
(10) Pub. No.: US 2002/0032639 A1
(43) Pub. Date: Mar. 14, 2002

(54) System & method for identifying compensation plans

(76) Inventors: Mathew Hausken, Chicago, IL (US); Paul Ivsin, Chicago, IL (US); Abdou Touray, Chicago, IL (US)

Correspondence Address: John E. Hyatt, Altheimer & Gray, 10 S. Wacker Drive, 35th Floor, Chicago, IL, 60606, US

(21) Appl. No.: 09/845,577

(22) Filed: Apr. 30, 2001

Related U.S. Application Data
(60) Provisional application No. 60/231,158, filed on Sep. 8, 2000.

(51) Int. Cl. G06F 17/60

(52) U.S. Cl. 705/37

(57) ABSTRACT

A system and method that suggests benefit plans to plan participants and plan sponsors as a function of user input. The suggestion process is preferably performed without human intervention. The suggestion process is performed by a system engine that objectively evaluates information provided by the plan sponsor and the plan participant. Preferably a rule-based question and weighted answer is used to determine acceptable plans. The system engine may use the supplied information in connection with a regulatory adaption agent and a case mapping agent to suggest zero or more benefit plans that best suit the interests of the plan sponsor or the plan participant or both.

### CROSS REFERENCE TO RELATE APPLICATIONS

This application claims the benefit of U.S. Provisional Application Ser. No. 60/231,158, filed Sep. 8, 2000, which is incorporated herein by reference.

### FIELD OF THE INVENTION

The present invention relates to benefit plans. Specific exemplary embodiments discussed relate to recommendation systems for suggesting non-qualified benefit plans.

### BACKGROUND OF THE INVENTION

This invention relates generally to employee compensation and benefits plans and, more particularly, to a system and method for automatically identifying compensation/benefits plans suitable for use by particular employees of a corporation. The terms “compensation” and “benefit” are used interchangably in this document and are intended to be contrued broadly. The terms “recommend” and “suggest” are to be construed broadly but not to imply any governmental regulatory connotation.

Corporations compensate employees in a variety of ways; the simplest being cash payment. More complex compensation packages include, for example, medical, day care, deferred compensation and matching. Compensation plans may be generally categorized as qualified or nonqualified.

A qualified plan is one that meets certain requirements imposed by, for example, the U.S. Internal Revenue Code; a 401K is an example of such a plan. The imposed requirements include, but are not limited to, minimum coverage, nondiscrimination requirements that prohibit an employer from providing benefits for only some employees, and limits on the benefit amounts. For example, for the year 2000, the annual limit for contribution by an employee to a 401K plan is $10,500.00. In return for complying with the requirements of a qualified plan, the corporation receives certain benefits, for example tax incentives.

A nonqualified benefit plan is, generally, an executive benefit plan that avoids limitations imposed by, for example, the Employee Retirement Income Security Act of 1974 (ERISA). Income to the employee and tax deductions for the employer are both, generally, deferred until when benefits are actually paid, often at retirement. A nonqualified benefit plan is not subject to the same minimum coverage and nondiscrimination requirements as qualified plans. Thus, a nonqualified plan can be designed to cover a limited group of employees. Also, a nonqualified plan can provide benefits in excess of those permitted under qualified plan limits. As a result, nonqualified plan tax treatment is not as favorable as that of qualified plans.

Modalities for deferring compensation or creating supplemental benefits plans are well known. In this regard, there is a set of four well known benefit plan approaches that corporations can choose from to offer to employees. The four widely-used nonqualified benefit plans (or plan types) are: (1) deferred compensation; (2) deferred compensation with employer match; (3) defined contribution; and (4) defined benefit. Each plan is explained further below. Each of these known benefit plans offers a set of advantages and disadvantages to the corporation offering the plan (also referred to herein as the plan sponsor) and to the employee participating in the plan (also referred to herein as the plan participant). Because of the varying advantages and disadvantages that these plans have, there is a tremendous interest on the part of both the employer and the employee to determine which plan is most appropriate for a given circumstance.

Presently, the determination as to which benefit plan is most appropriate for a given circumstance is made by human consultants. A consultant gathers details including compensation levels, employer and employee objectives, and company and employee attributes and then suggests a benefit plan to use based upon the information gathered. Unfortunately, the myriad of factors involved in this suggestion process often results in the suggestion by the consultant of a benefit plan that is not appropriate for the plan sponsor or the plan participant. One factor that often leads to an incorrect suggestion of a benefit plan is the requirement that the consultant base the suggestion on projections that involve nonlinear mathematical computations. Since these computations are particularly difficult to perform, the benefit plan that ultimately get suggested by the consultant often has very little to do with the interests of the plan sponsor or the plan participant and more typically serves the interests of the suggesting consultant.

As a result of these shortcomings in the currently implemented system for determining benefit plan, a need exists for an improved system and method for identifying benefit plans for employees of a corporation. More particularly, a need exists for an impartial, adaptive, and scientific approach for use in suggesting benefit plans to plan participants and plan sponsors.

### SUMMARY OF THE INVENTION

As a result of these needs, the present invention is realized in a system and method that suggests benefit plans to plan participants and plan sponsors as a function of user input. The suggestion process, e.g., the analysis of objectives and selection of a plan, is preferably performed without human intervention. The suggestion process is performed by a system engine that objectively evaluates information provided by the plan sponsor and the plan participant. The information, in one embodiment, is acquired using a rule-based question and weighted answer, e.g. a logic tree, method. Using a set of uniform questions eliminates any potential bias due to a human consultant. And basing the plan type suggestion solely on plan sponsor input normalizes the process for each individual potential plan participant. The system engine may use the information in connection with a regulatory adaption agent and a case mapping agent to recommend zero or more benefit plans that best suit the interests of one or both of the plan sponsor and the plan participant.

A better understanding of the objects, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF THE DRAWINGS

FIG. 1 is a flow chart for acquiring sponsor or participant input via a quiz method.

FIG. 2 depicts the data flow for the quiz method depicted in FIG. 1.

FIG. 3 diagrammatically depicts a plan suggestion process incorporating a regulatory adaption agent and case mapping.

FIGS. 4A-4D list questions for a logic tree to be used with the quiz.

FIGS. 5A-5D list scoring and weighting corresponding to the questions listed in FIGS. 4A-4D.

FIGS. 6A-6D list a purpose corresponding to each question listed in FIGS. 4A-4D.

FIGS. 7A-7K depict screen shots associated with a user interface for the quiz and system; some screens include a graphical representation of the cumulative scores for each of the four nonqualified benefit plans.

### DETAILED DESCRIPTION

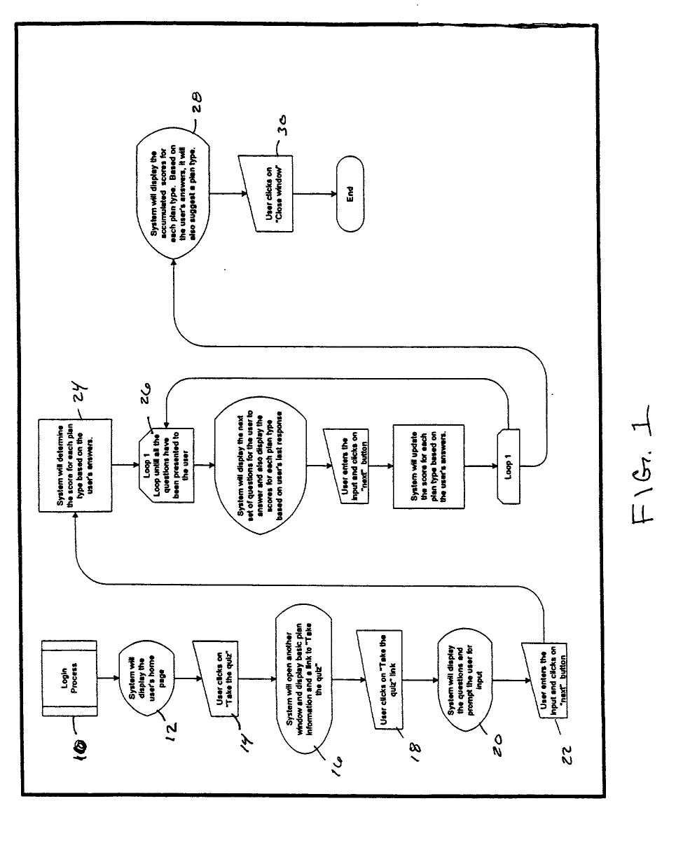

FIG. 1 depicts a process for acquiring sponsor or participant input concerning a benefit plan. The sponsor is the provider, e.g., the corporation, providing the benefit plan to the participant, e.g., the employee. It will be understood that typically the sponsor is a potential sponsor and the employee is a potential participant because a plan has not yet been selected and implemented. Accordingly, the qualifier “potential” is generally excluded from the descriptions.

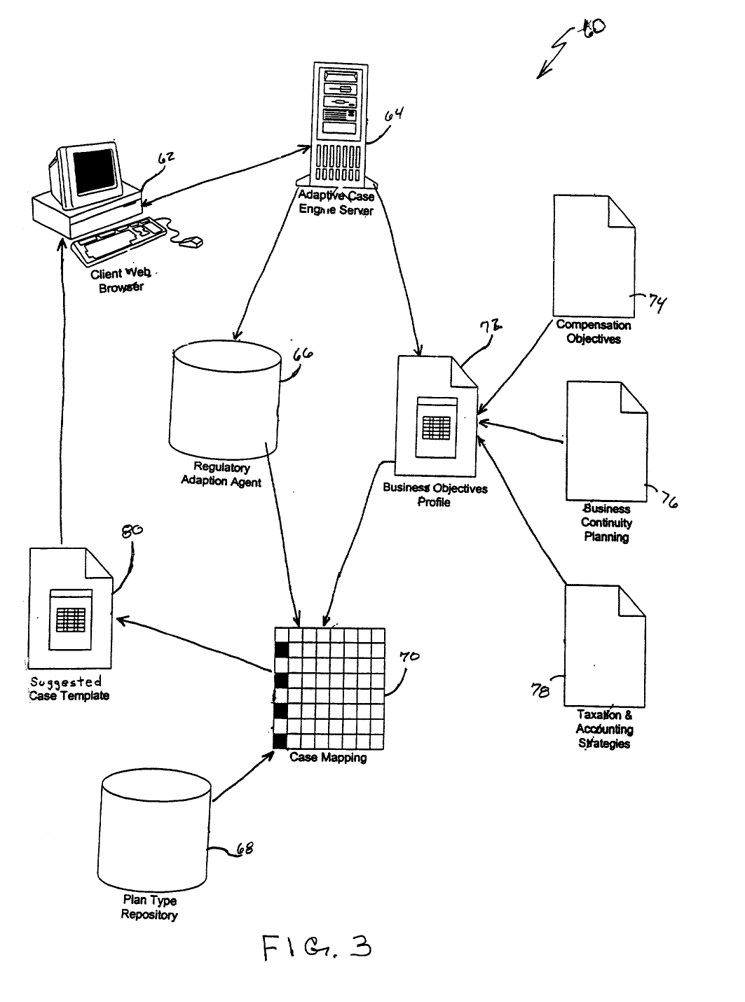

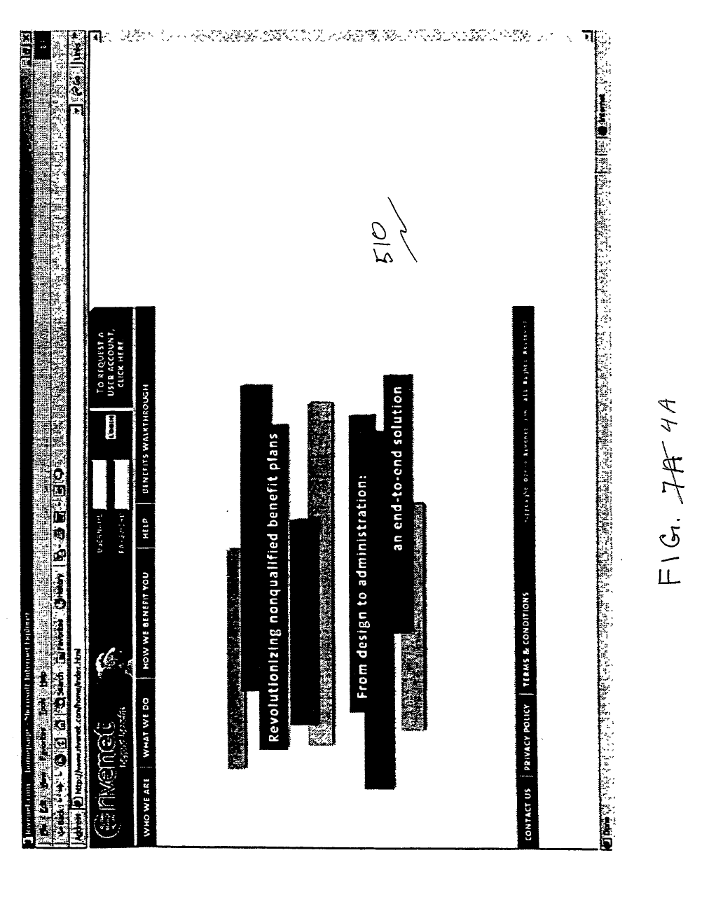

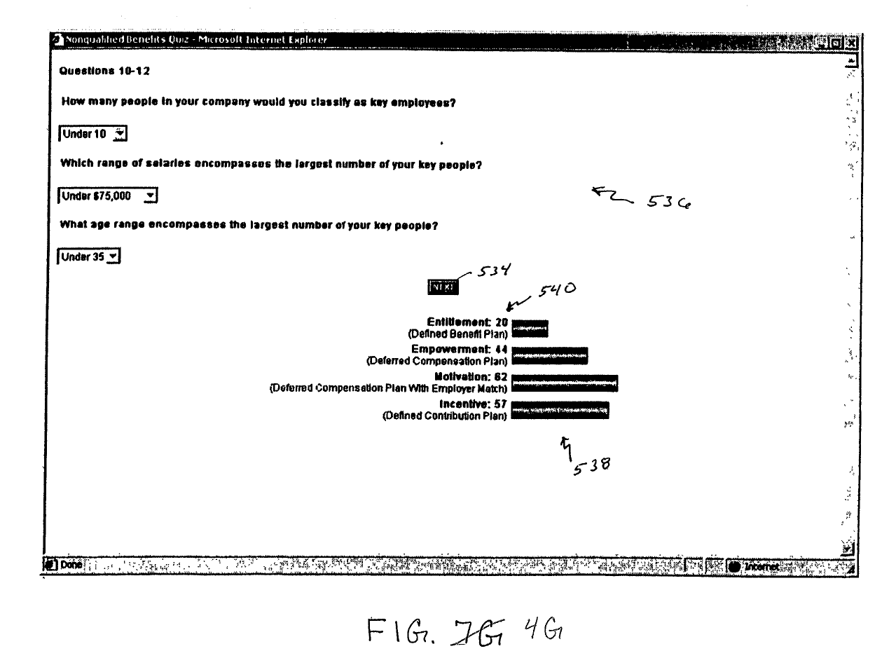

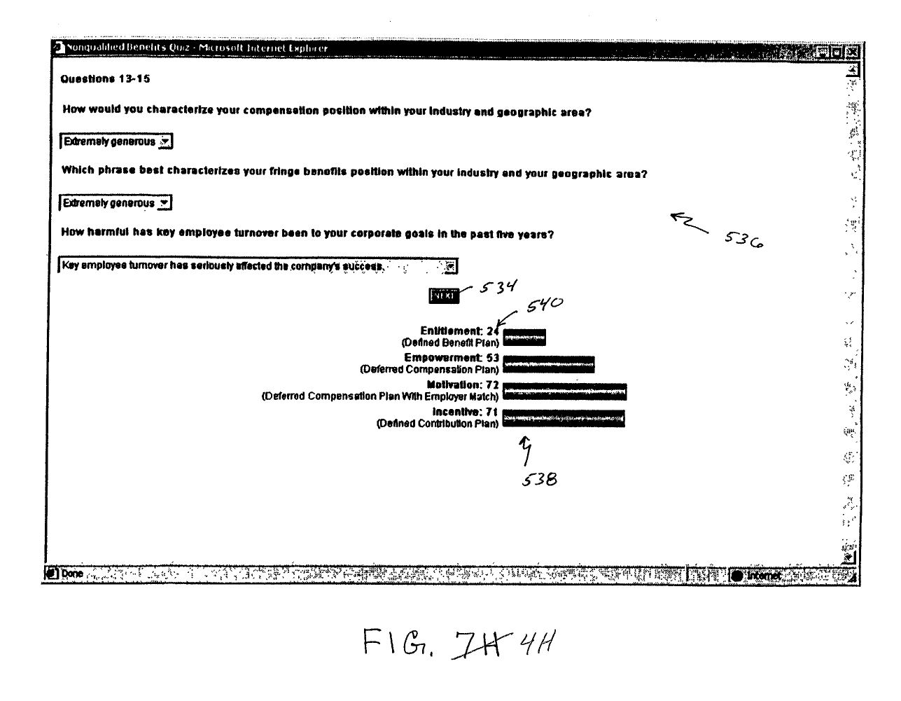

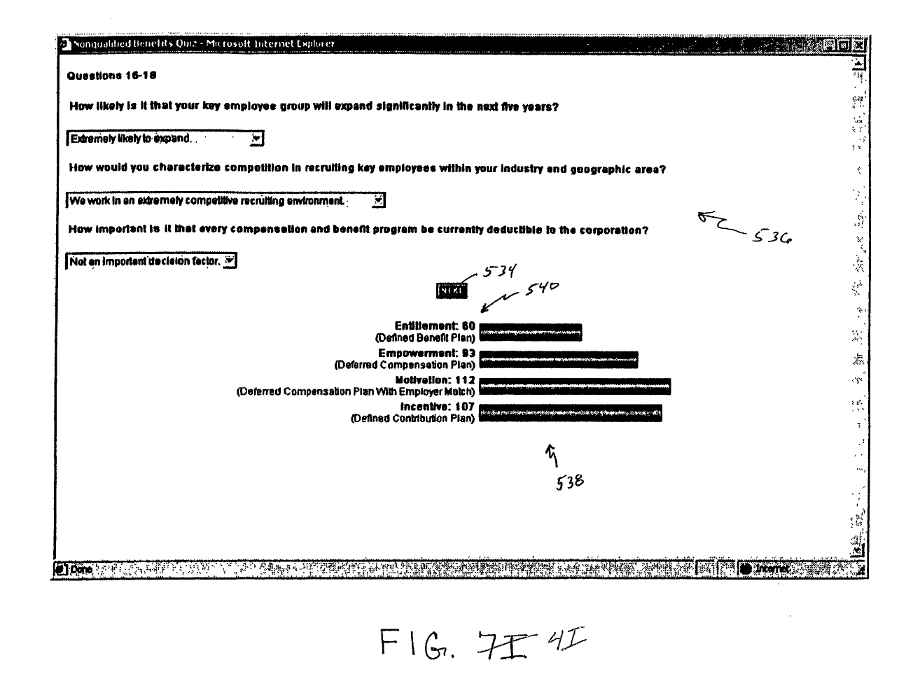

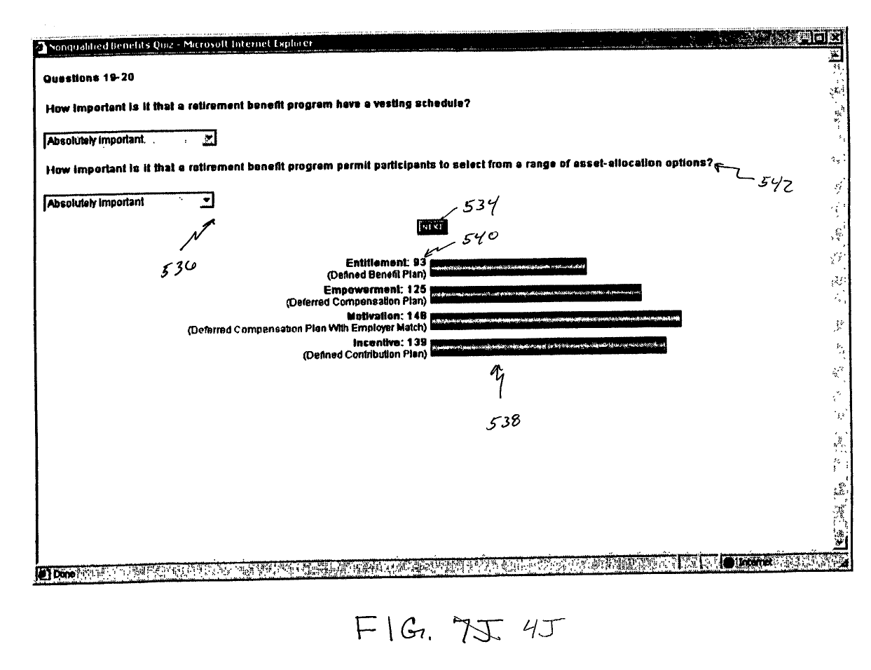

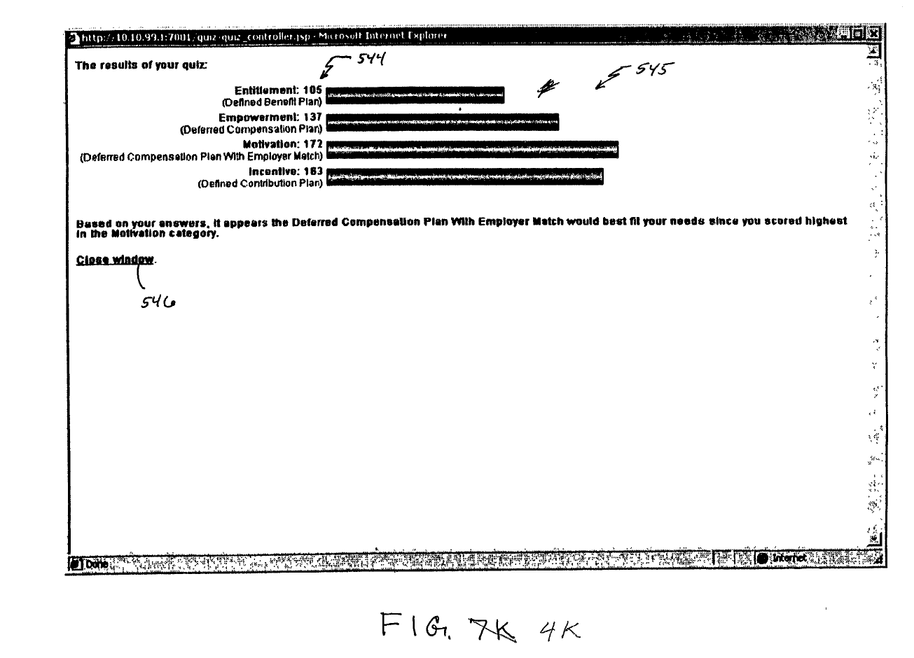

In operation, when a user desires to attain information regarding benefit plans that would be suited to the needs of the plan sponsor and/or the plan participant, the user utilizes the Web browser on a client computer to access an adaptive case engine server. The user may be required to logon to the adaptive case engine server or be otherwise verified as a recognized user of the system before gaining access to the system. Once the user has been verified as a recognized user, the user will be prompted to answer a series of questions, e.g., the twenty questions in FIG. 4. The questions are preferably presented to the user in the form of Web pages such as depicted in FIG. 7 and discussed further below. The Web pages may provide drop down answer menus or check boxes by which the user may answer the questions posed on the Web pages. The questions, which may be both subjective and objective, are provided to gather specific information about one or both the plan participant and the plan sponsor and may be provided in a fixed sequence from a static database. The questions may concern information related to, for example, the size of the corporation, the type of corporation, the compensation level of the employee, financial objectives of the corporation, financial objectives of the employee, etc. Based upon the answers that the user provides the system identifies the benefit plan(s) that is deemed to be best suited for the needs of one or both of the plan sponsor and the plan participant. In one approach, an aggregate score is calculated from weights associated with questions and answers.

With reference to FIG. 1 and FIG. 7, on logging in to the system website 510, the system will display the sponsor's home page 512. Steps 10-12.

When the sponsor clicks on the take the quiz option 54, the system will open another browser window 516 and display basic information 518 on the advantages of taking the nonqualified benefits plan quiz. The system will also provide a link 520 to take the quiz. Steps 14-16.

When the sponsor selects the take the quiz link 520, the system will display in a new browser window the first three questions 522, 524 and 526 of the nonqualified benefits plan quiz and prompt the sponsor to enter responses 528, 530 and 532. Steps 18-20.

When the sponsor has entered his responses and clicked the next button 534, the system will display the next set of questions 536 in the quiz, as well as a bar graph 538 and number 540 indicating the cumulative score for each of the four nonqualified benefit plan types. This process will continue until the sponsor has answered all twenty of the questions. Steps 24-26.

After the sponsor has answered the last question 542 and clicked next 534 or submit, the system will display the total accumulated score 544 for each of the four plan types. The system will suggest that, based on the sponsor's answers, the plan type that has received the highest cumulative score is best suited to meeting that sponsor's particular needs. Step 28.

Clicking on the close window button 546 Step 30 will close the browser window and end the nonqualified benefits plan quiz.

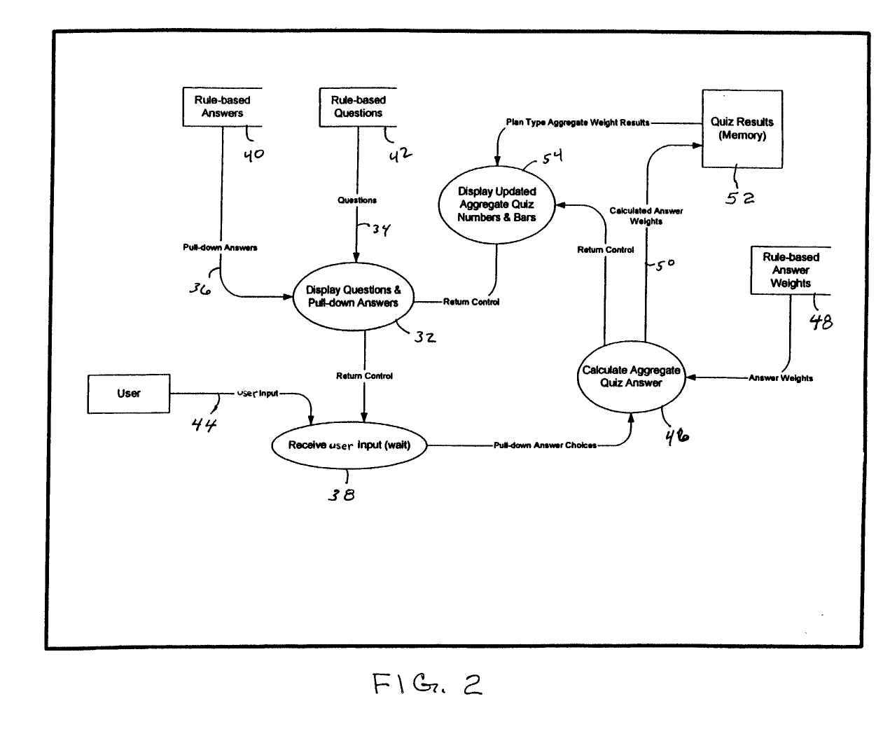

Data flow for the quiz process is depicted in FIG. 2. The system displays the appropriate questions and corresponding pull-down answers, retrieves the rule-based answers and questions from the appropriate data stores 40 and 42, and waits for the sponsor to input his answer choices. Steps 32-38.

The sponsor inputs his answer choices via a user interface such as represented by FIG. 7. Step 44.

When the sponsor's pull-down answer choices have been inputted, the system calculates the aggregate quiz answer, drawing on the rule-based answer weights data store 48 and correlating that with the sponsor's pull-down answer choices. Step 46.

The system outputs the calculated answer weights to the quiz results data store 52, where they are incorporated into the plan type aggregate weight results for the quiz. Step 50.

Using the plan type aggregate weight results, the system displays the updated aggregate quiz score numbers and the corresponding bar graphs. Step 54.

If the quiz has not been completed, the system displays the next set of questions and pull-down answers. Step 32 again.

Turning now to FIG. 3, there is illustrated a system 60 and method for identifying benefit plans for employees of a corporation without the need for a human consultant. The system 60 is implemented on a network, such as the Internet, by which one or more client computers 62 and one or more adaptive case engine servers 64 communicate. The client computers 62 and adaptive case engine servers 64 preferably include a Java Virtual Machine such that the system and method for identifying benefit plans may be utilized without regard to the underlying platforms of the client computers 62 and adaptive case engine servers 64. According to this preferred embodiment, the programs on the client computers 62 and adaptive case engine servers 64 that implement the system and method for encrypted message interchange are also preferably implemented in the JAVA language. To allow the client computers 62 to access and communicate with the adaptive case engine servers 14, the client computers 12 include a conventional Web browser.

The case engine servers 64 may utilize a regulatory adaption agent 66 and a plan type repository 68. The regulatory adaption agent 66 utilizes a database of various rules and regulations related to the field of compensation and benefits for different types of corporations. The plan type repository 68 utilizes a database of benefit plans, in particular, deferred compensation plans.

To ensure that any suggested benefit plan would not violate any agency or regulatory rules, selected answers gathered from the sponsor (more generally the user) are provided to the regulatory adaption agent 66. The regulatory adaption agent 66 evaluates the information it is provided to identify certain benefit plans as not being appropriate for suggestion. More specifically, the regulatory adaption agent 66 compares the information it is supplied against the various rules contained in its associated database and flags certain attributes of benefit plans as not being appropriate for the plan participant and plan sponsor. These flagged attributes are forwarded to a case mapping engine 70 for further use in identifying which benefit plan(s) should be suggested.

For identifying which benefit plans would be best suited for the objectives of the sponsoring business, a business objectives profile 72 for the plan participant and the plan sponsor is created from the answers provided by the user. The business objectives profile 72 is a collation of the compensation objectives of the plan sponsor and the plan participant, the business continuity objectives (if any) of the plan sponsor 76, and the taxation and accounting strategies of the plan sponsor and the plan participant 78. The information in the business objectives profile 72 is forwarded to the case mapping engine 70 for further use in identifying which benefit plan(s) should be suggested.

To identify which benefit plans should be suggested to the user, the case mapping engine 70 compares the information provided by the regulatory adaptive agent 66 and the information in the business objectives profile 72 with the attributes of the various plans maintained in the plan type repository 68. In this regard, the case mapping engine 70 eliminates from possible identification for suggestion those benefit plans that have attributes that have been flagged by the regulatory adaption agent 66. The case mapping engine 70 also eliminates from possible suggestion those benefit plans that do not have attributes that favorably compare to the business objectives profile 72.

To assist in the comparison between the benefit plans and the business objectives profile 72, the case mapping engine 70 calculates a numerical strength of the business objectives profile 72. The numerical strength can be expressed as:

numerical strength=Σ(Qₓ*Aₓ) (1)

where the numerical strength is the sum of a numerical weight (Q) provided to selected questions asked of the user multiplied by a numerical weight (A) provided to the answer given by the user in response to the corresponding question. This calculated numerical weight is then compared to numerical weight ranges that have been assigned to each of the benefit plans within the case mapping engine 70. The numerical weight ranges are assigned to the benefit plans as a function of the attributes of the benefit plans. Accordingly, the case mapping engine 20 eliminates from possible identification for suggestion those benefit plans that have a numerical strength range that does not include the calculated numerical range of the business objectives profile 72. The benefit plans that have not been eliminated by the case mapping engine 70 are then returned to the user as the benefit plan(s) that the system suggests for use by the plan sponsor and plan participant. When returned to the user, the suggested benefit plans can be scripted into a suggestion template 80 whereby the user may view the attributes of the suggested plans (either singularly or side-by-side) using their Web browser.

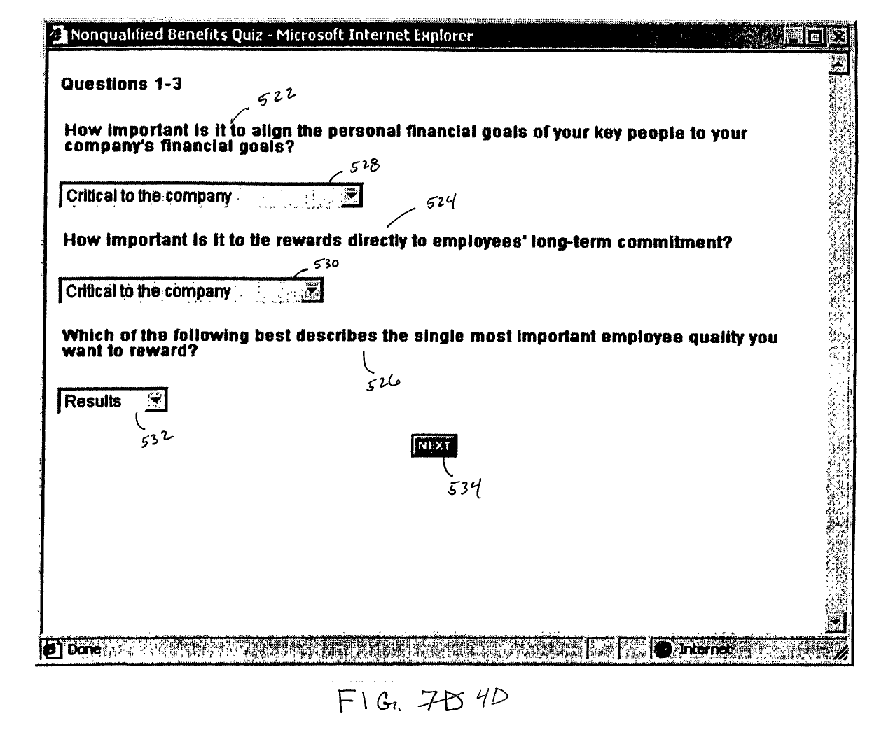

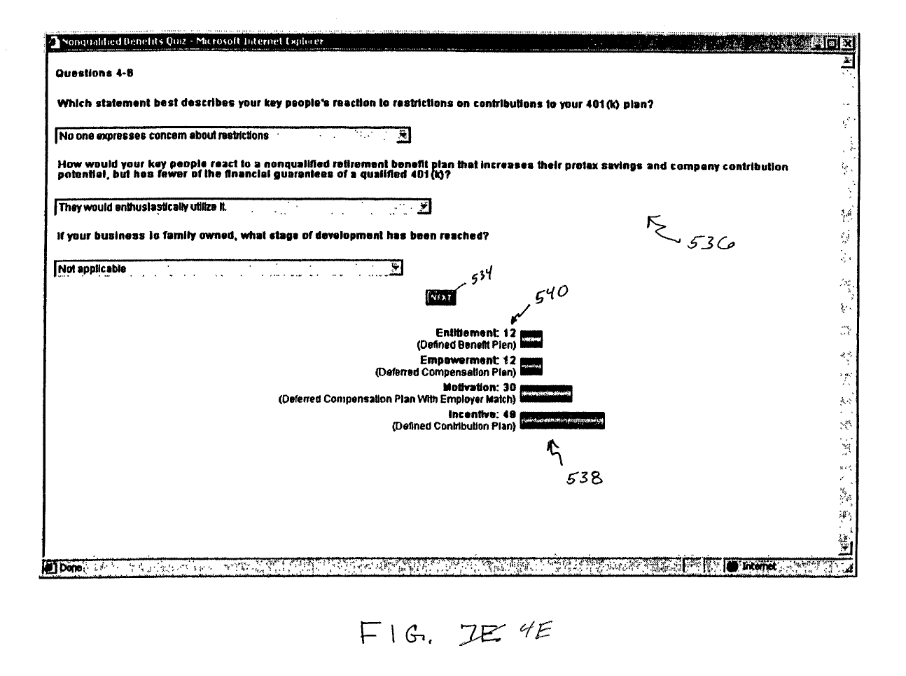

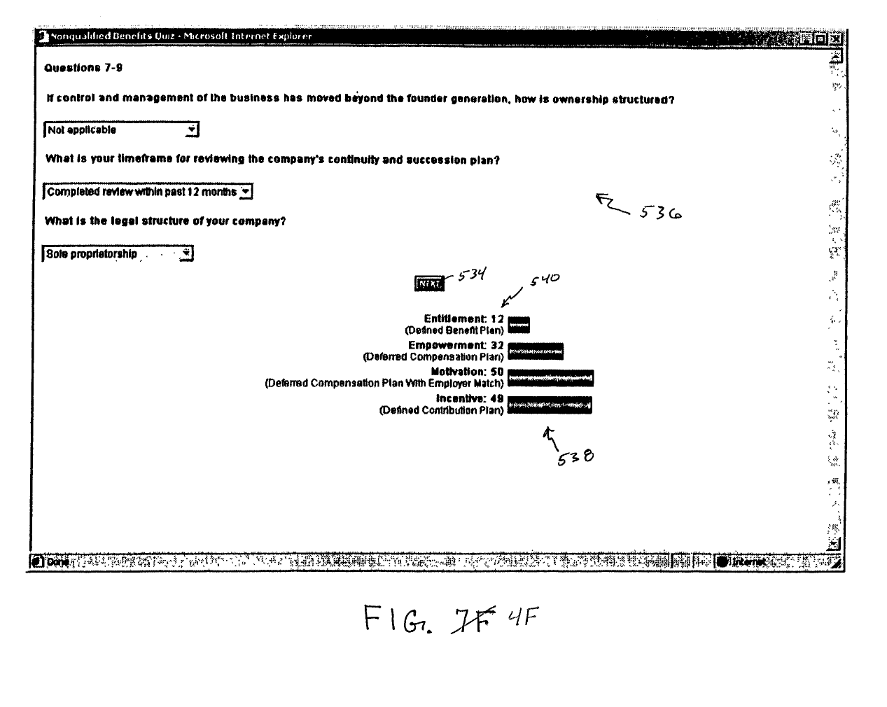

The logic tree represented by FIGS. 4-6 is an analytical tool that is adapted to, for example, identify relationships between a company's particular needs and different nonqualified benefit plans. The logic tree may be adapted to identify the relative suitability, for example, of the four nonqualified plans mentioned in the background section. The nonqualified benefit plans are: (1) deferred compensation (Def Comp); (2) deferred compensation with employer match (Def Comp Match); (3) defined contribution (DC SERP); and (4) defined benefit (DB SERP). In a deferred compensation plan, the employer enters into an agreement with the employee to permit the employee to defer a certain portion of their compensation until retirement. A deferred compensation with match plan functions in essentially the same manner as a standard deferred compensation plan. In a deferred compensation with match plan, however, the employer agrees to contribute an amount in addition to the compensation that the employee chooses to defer. In a defined contribution plan, the employer enters into an agreement with the employee, agreeing to make contributions to an account for the employee's retirement. The contributions to the plan are a set amount defined by the employer. In a defined benefit plan, the employer enters into an agreement with the employee to provide an annual retirement income benefit. The benefit is a set amount defined by the employer.

The identification of the plan's suitability may be based upon a specific set of question and answers 90A, 90B, 90C and 90D. Typically a company's solution is a combination of two or more types of plans. The logic tree is used to rate each plan and present key issues for the planner and the company to discuss to implement a reasoned nonqualified benefits strategy. A quiz administration tool may be adapted to allow an authorized individual to add, modify, delete, resort, etc., questions in a static tree. Individual answer and question weights may also be modified.

Purpose—

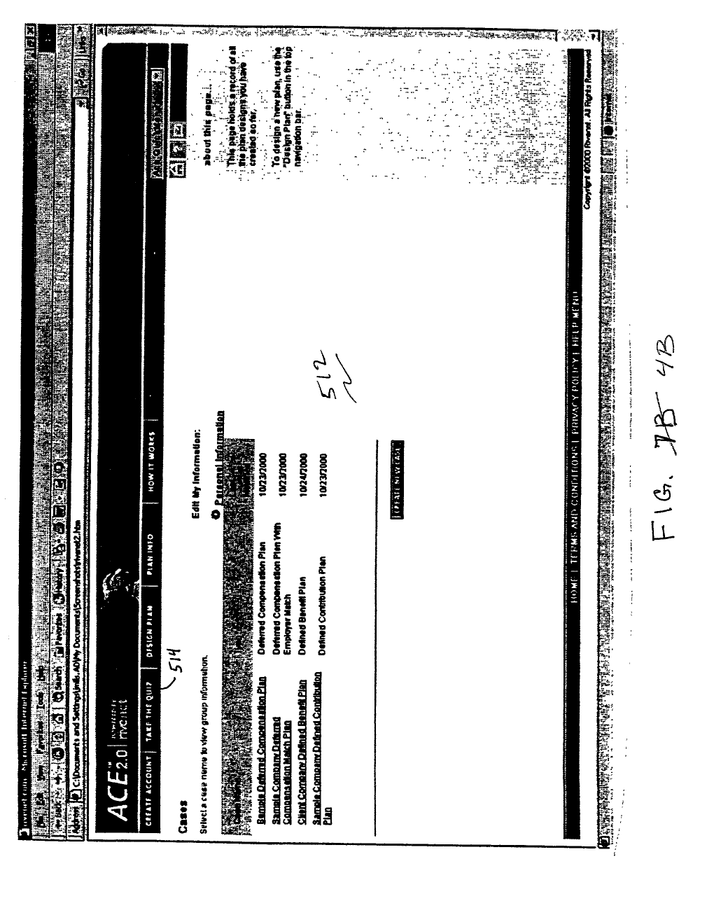

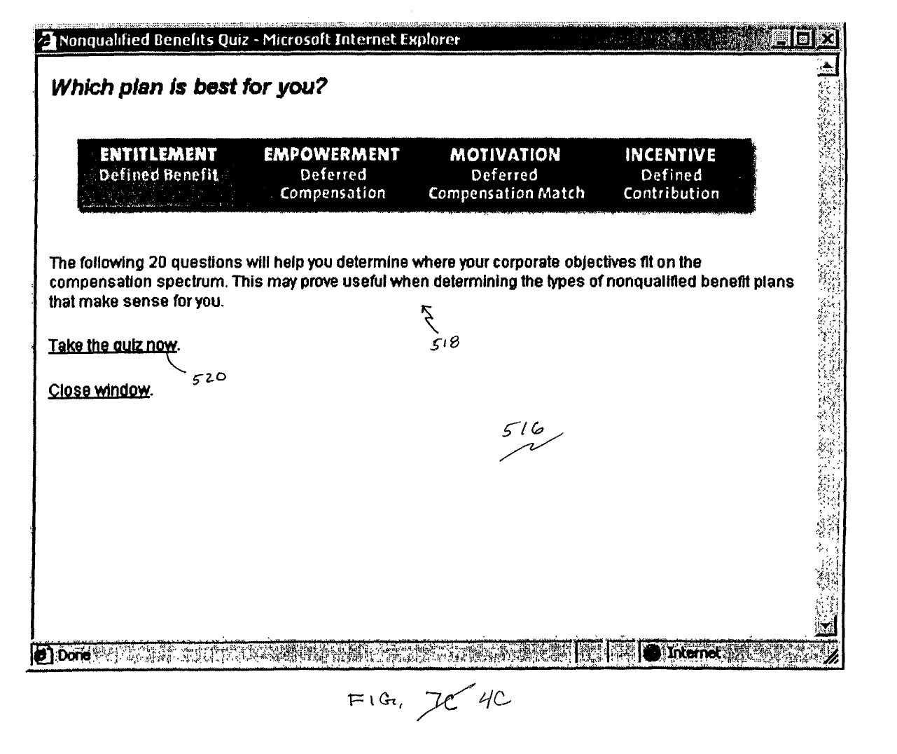

Each question in the specific set 90A-90D has a specific set of purposes 92A-92D. This purpose set 92A-92D is represented in FIG. 5. The questions preferably span the key components of plan design.

Weighting and Scoring—

The scoring 94A-94D of each question and answer is based upon a two tier weighted scoring system. Weighting of a particular questions 96A-96D and answers 98A-98D is determined based upon relevance to particular plan types and significance in defining corporate needs and objectives.

Answer Weight—

Each potential answer to each question in the quiz is given an answer weight 98A-98D ranging from 0 to 4 for each of the four nonqualified benefit plans. These plan types are discussed above.

Question Weight—

Each question in the quiz is given a question weight 96A-96D ranging from 1 (least significant) to 5 (most significant), reflecting the relative importance of the corresponding question in determining nonqualified benefit plan needs.

Total Weighting—

Each potential answer score is calculated by multiplying each answer weight 98A-98D by the question weight 96A-96D. The total weighted score 100A-100D for each potential answer and benefit type is shown in the center column of FIG. 5.

When an answer is selected, scoring is determined by taking the total weighting 100A-100D for each of the plan types (Def Comp, Def Comp Match, DC SERP, DB SERP) for that answer. As one proceeds through the quiz, scores are added cumulatively for each of the plan types. When the end of the quiz is reached, the system will display the relative scores for each of the four plan types and indicate the nonqualified benefit plan type with the highest total score. FIGS. 4 and 5 demonstrates how the scoring would be calculated for a sample sequence of answers. The total weighting in FIG. 5 corresponding to an answer in FIG. 4 is used as the answer score; each plan has an answer score for each question.

With reference to FIG. 7, when the sponsor (or participant) chooses to take the quiz, the system presents twenty multiple-choice questions. (See FIGS. 7D-7J.) The sponsor answers these multiple-choice questions and the system presents a bar graph 538 and a numerical score 540 indicating the relative suitability of each plan type based on the user response. At the end of the process the system will display the cumulative results 544 and 545 of the quiz, indicating the relative scores among the four plan types and recommending the plan type with the highest cumulative score as most appropriate to the sponsor's specified needs. (See FIG. 7K.)

While specific embodiments of the invention have been described in detail, it will be appreciated by those skilled in the art that various modifications and alternatives to those details could be developed in light of the overall teachings of the disclosure. For example, the regulatory adaption agent can be used to flag attributes that are acceptable to the plan sponsor and plan participant; the case mapping agent adapted to select, rather than eliminate, those plans having flagged attributes. Similarly, the case mapping agent can select, rather than eliminate, those plans that have a numerical weight range that includes the calculated numerical weight. In such a case, the user would be returned those plans that have been selected by both of these procedures. Accordingly, the particular arrangement disclosed is meant to be illustrative only and not limiting as to the scope of the invention which is to be given the full breadth of the appended claims and any equivalents thereof.

The invention claimed is:

1. A method of suggesting a benefit plan from a selection of benefit plans wherein the selection of plans comprises at least two different plans and wherein the method comprises:
presenting a series of predetermined questions to a user, wherein each question has a question weight associated therewith;
presenting a predetermined selection of answers for each question, wherein each answer has an answer weight associated therewith for each plan in the selection of plans;
aggregating an answer score for each plan per each question, wherein the answer score is based upon an answer selected by the user, the answer weight associated with the answer selected and the question weight associated with the question answered; and
suggesting the plan having the largest aggregated answer score associated therewith.

2. A logic tree for use in a method of suggesting a benefit plan from a predetermined selection of benefit plans, the logic tree comprising:
a series of business objective questions;
a question weight associated with each question;
a predetermined selection of answers for each question; and
a plurality of answer weights associated with each answer, wherein each one of the plurality of answer weights is respectively associated with each one of the selection of benefit plans, whereby a particular answer score may be determined based upon a particular answer weight and a particular question weight.

3. A computer readable medium useful for suggesting a benefit plan comprising:
at least two benefit plans;
a series of questions, each having a question weight associated therewith;
a selection of answers associated with each question; and
an answer weight associated with each one of the selection of answers for each of the at least two benefits plans, whereby there is an answer weight associated with each answer-question-plan combination.

4. A method of suggesting a benefit plan from a plurality of benefit plans, the method comprising:
transmitting to a user a series of questions and a selection of answers for each question;
receiving answer inputs from the user;
determining an aggregate score for each benefit plan based upon the received answer inputs; and
transmitting a suggestion for at least one benefit plan based upon the aggregate score of each plan.

5. The method of claim 4, comprising transmitting a graphical representation of the aggregate scores.

6. The method of claim 4, comprising transmitting the aggregate score.

7. The method of claim 4, comprising transmitting the aggregate score associated with each benefit plan after every group of a predetermined number of questions have been answered.

8. The method of claim 4, comprising determining an answer score for each plan per question.

9. The method of claim 8, wherein the answer scores are based upon question weights and answer weights.

10. A system for suggesting a benefit plan that is adapted to operate in a client-server environment comprising at least one client computer, the system comprising:
a series of questions, each question having a question weight associated therewith;
a selection of answers associated with each question;
a plurality of benefit plans;
a plurality of answer weights comprising an answer weight associated with each answer-question-plan combination;
means for transmitting the questions to the client computer;
means for receiving answers inputs from a user at the client computer;
means for determining an answer score for each plan for each question based upon the answer weights and the question weights; and
means for suggesting at least one benefit plan based upon the answer scores associated with each plan.

11. The system of claim 10, comprising means for representing at the client computer an aggregate answer score associated with each plan.

12. A method of normalizing a benefit suggestion process for individual users, the method comprising:
presenting a uniform set of questions and answers to individual users;
receiving answer input from a potential-plan sponsor;
determining an answer score corresponding to each potential plan for each question based only on predetermined weighting factors and input received from the potential-plan sponsor; and
suggesting a benefit plan based upon the answer scores, whereby the suggestion is normalized.
